(19) United States
(12) Patent Application Publication
(10) Pub. No.: US 2012/0072121 A1
(43) Pub. Date: Mar. 22, 2012

(54) SYSTEMS AND METHODS FOR QUALITY CONTROL OF COMPUTER-BASED TESTS

(75) Inventors: Daniel Joesph Mollicone, Philadelphia, PA (US); Christopher Grey Mott, Seattle, WA (US)

(73) Assignee: Pulsar Informatics, Inc., Philadelphia, PA (US)

(21) Appl. No.: 13/237,758

(22) Filed: Sep. 20, 2011

Related U.S. Application Data
(60) Provisional application No. 61/384,691, filed on Sep. 20, 2010.
(60) Provisional application No. 61/481,039, filed on Apr. 29, 2011.

(51) Int. Cl. G06F 19/00

(52) U.S. Cl. 702/19

(57) ABSTRACT

Disclosed are systems and methods for monitoring, inter alter, administration compliance, test subject identity, and results quality of computer-administered tests. A test administration unit, an audio-visual data collection unit, and an audio-visual data processing unit are configured to detect testing anomaly events within the testing environment by analyzing audiovisual data from the test subject and environment itself. Disclosed methods include modifying or amending test results because of detected testing anomaly events within the testing environment, verifying the identity of the test subject, and monitoring for compliance with test-administration protocols. Additional methods disclosed include: user facial analysis, including gaze point analysis, for indirect detection of testing anomaly events; user verification using facial recognition, voice recognition, retinal scans, and or other audiovisual biometric protocols; and the like.

### RELATED APPLICATIONS

This application claims benefit of the priority of U.S. application No. 61/384,691 filed Sep. 20, 2010 and U.S. application No. 61/481,039, filed Apr. 29, 2011, both of which are hereby incorporated herein by reference.

### TECHNICAL FIELD

The invention relates to systems and methods for performing quality control of neurobehavioral computer-based tests. Particular embodiments involve verifying the identity of the test subject, detecting non-compliance with testing standards, and monitoring the testing environment for potential distractions to the test subject.

### BACKGROUND

Interactive tests may be delivered on computer platforms to evaluate a wide variety of subjects, content, characteristics, and traits of test subjects. The widespread availability of suitable computer platforms allows delivery of tests in laboratory, commercial, and private environments. The accuracy and reliability of the results from such tests depends on confirmation of the identity of test subjects and compliance with testing protocols and procedures. Especially in environments outside of controlled laboratories, meeting accuracy and reliability criteria objectives can be difficult.

To maintain quality control for such computer-based tests, there is a general desire for systems and methods that can monitor compliance and/or test-subject identity in an automated manner.

### SUMMARY

One aspect of the invention provides a system for controlling quality of a computerized test administered to a human test subject, the system comprising: a test administration unit for administering the test to the human test subject in a test environment; an audiovisual data collection unit for collecting quality control data, the quality control data comprising at least one of audio data, image data and video data relating to at least one of the test subject and the test environment; and an audiovisual processing unit for analyzing the quality control data to detect, from within the quality control data, a testing anomaly event which may indicate that the reliability of results of the test has been compromised; wherein, in response to a detected testing anomaly event, at least one of the audiovisual processing unit and the test administration unit is configured to adjust at least one of the administration and results of the test.

The testing anomaly event may comprise one or more of a distraction event indicating that the test subject may have been distracted while performing the test; and a non-compliance event indicating that the test subject may have violated one or more testing protocols associated with the test.

The quality control data may comprise quality control audio data. The audiovisual processing unit may be configured to detect the testing anomaly event based at least in part on an audio intensity level of the quality control audio data being greater than an audio intensity threshold. The audiovisual processing unit may be configured to detect the testing anomaly event based at least in part on a rate of change of audio intensity level of the quality control audio data being greater than an audio intensity rate of change threshold. The audiovisual processing unit may be configured to detect the testing anomaly event based at least in part on a change in a frequency spectrum of the quality control audio data being greater than an audio frequency spectrum threshold. The audiovisual processing unit may be configured to detect the testing anomaly event based at least in part on a rate of change in a frequency spectrum of the quality control audio data being greater than an audio frequency spectrum rate of change threshold. The audiovisual processing unit may be configured to detect the testing anomaly event based at least in part on comparing a frequency spectrum of the quality control audio data to frequency spectra of one or more of: known model distraction events, and known model non-compliance events. The known model distraction events may comprise speech frequency patterns.

The quality control data may comprise quality control image data relating to the test subject. The audiovisual processing unit may be configured to detect the testing anomaly event based at least in part on a position of one or more parts of the body of the test subject changing within the quality control image data by an amount greater than a body movement threshold. The audiovisual processing unit may be configured to detect the testing anomaly event based at least in part on a position of one or more parts of the body of the test subject changing within the quality control image data at a rate greater than a body movement rate of change threshold. The quality control image data may comprise image data corresponding to one or more eyes of the test subject, and the audiovisual processing unit may be configured to process the quality control image data to estimate a gaze point of the test subject and to detect the testing anomaly event based at least in part on a gaze point of the test subject being outside of a bounding region.

The quality control data may comprise quality control image data relating to the test environment. The audiovisual processing unit may be configured to detect the testing anomaly event based at least in part on the light level, changes in the light level, or the rate of change of the light level in the test environment being greater than a light level threshold. The audiovisual processing unit may be configured to detect the testing anomaly event based at least in part on a position of one or more objects in the test environment changing within the quality control image data by an amount greater than an object movement threshold.

The audiovisual processing unit may be configured to record a temporal characteristic of the detected testing anomaly event, the temporal characteristic comprising at least one of a time of onset of the detected testing anomaly event and a temporal duration of the detected testing anomaly event. The at least one of the audiovisual processing unit and the test administration unit may be configured to adjust the at least one of the administration and the results of the test based at least in part on the temporal characteristic of the detected testing anomaly event.

The test administration unit may comprise: a stimulus output device for providing a stimulus to the test subject; a response receiver for detecting a response of the test subject to the stimulus; and a test controller for administering a stimulus-response test which involves measurement of the test results (including without limitation the time intervals between the provision of stimulus to the test subject and detected responses of the test subject). The at least one of the audiovisual processing unit and the test administration unit may be configured to adjust at least one of the results or measured time intervals between the provision of stimulus to the test subject and detected responses of the test subject in response to the detected testing anomaly event. The audiovisual processing unit may be configured to record a temporal characteristic of the detected testing anomaly event, the temporal characteristic comprising at least one of a time of onset of the detected testing anomaly event, time of cessation of the detected testing anomaly event, and a temporal duration of the detected testing anomaly event. The at least one of the audiovisual processing unit and the test administration unit may be configured to adjust the at least one of the results or measured time intervals based at least in part on the temporal characteristic of the detected testing anomaly event. The stimulus-response test may comprises a psychomotor vigilance test.

At least one of the test administration unit, the audiovisual data collection unit, and the audiovisual processing unit may be distributed across a computer network.

The audiovisual data collection unit may be configured to collect identity verification data, the identity verification data comprising at least one of audio data, image data and video data relating to the test subject. The audiovisual processing unit may be configured to analyze the identity verification data to verify an identity of the test subject. (The user identity verification task may also be accomplished by optional biometric sensors or security devices attached to the system, such as without limitation: thumbprint or fingerprint readers, iris or scanners, password and/or user ID log-in sequences, voice recognition, card scanners, USB security keys, and/or the like.) The audiovisual processing unit may be configured to perform at least one of processing the identity verification data to determine an iris scan signature of the test subject and verifying the identity of the test subject by comparing the iris scan signature of the test subject to one or more previously ascertained iris scan signatures of the test subject; processing the identity verification data to determine a facial signature of the test subject and verifying the identity of the test subject by comparing the facial signature of the test subject to one or more previously ascertained facial signatures of the test subject; and processing the identity verification data to determine a voice signature of the test subject and verifying the identity of the test subject by comparing the voice signature of the test subject to one or more previously ascertained voice signatures of the test subject.

The at least one of the audiovisual processing unit and the test administration unit may be configured to adjust at least one of the administration and results of the test by one or more of: eliminating one or more of the results in response to a detected testing anomaly event; annotating one or more of the results in response to a detected testing anomaly event; deducting the temporal duration of the testing anomaly event from the measured response time; eliminating one or more response times from the calculation of a statistical metric of a stimulus-response test (including without limitation the psychomotor vigilance test) if the testing anomaly event temporally coincides with one or more response intervals corresponding to the one or more eliminated response times; adjusting a calculation of a statistical metric afire test if the testing anomaly event temporally coincides with one or more response intervals; propagating an uncertainty interval through a calculation of a statistical metric of the test if the testing anomaly event temporally coincides with one or more response intervals; terminating the test prematurely in response to a testing anomaly event; temporarily suspending administration of the test in response to a testing anomaly event and possibly resuming administration of the test only after the testing anomaly event has ended; displaying a message to the test subject in response to a testing anomaly event; waiting for feedback from the test subject in response to a testing anomaly event; making adjustments during the administration of the test, in response to a testing anomaly event; and making adjustments after the administration of the test has ended, in response to a testing anomaly event.

The system may further comprise an administrator management unit, wherein an administrator can review the test results including any test results adjusted in response to detection of a testing anomaly event.

Another aspect of the invention provides a method for controlling quality of a computerized test administered to a human test subject, the method comprising: administering a computerized test to the test subject in a test environment; collecting quality control data comprising at least one of audio data, image data and video data relating to at least one of the test subject and the test environment; analyzing the quality control data to detect, from within the quality control data, a testing anomaly event which may indicate that a reliability of results of the test has been compromised; and adjusting at least one of the administration and the results of the computerized test in response to a detected testing anomaly event.

Such a method may have further features similar to those discussed above for the system.

### BRIEF DESCRIPTION OF THE DRAWINGS

In drawings which depict non-limiting embodiments of the invention:

FIG. 1 is a schematic illustration of a system for administering and controlling the quality of a computer-based test according to an example embodiment;

FIGS. 2A, 2B, 2C are pictorial illustrations of three example embodiments of the system shown schematically in FIG. 1;

FIG. 3 is a schematic illustration of a system for administering and controlling the quality of a computer-based test according to another example embodiment that utilizes a distributed network connection;

FIG. 4 is a flow chart showing a method for facial video processing to determine head orientation and facial signature, according to a particular embodiment;

FIG. 5 is a flow chart showing a method for administering a computer-based test using audio and video analysis for quality control, according to a particular embodiment;

FIG. 6 is a flow chart showing details of a method for in-test analysis and feedback of audio and video signals for quality control, according to a particular embodiment that is suitable for use with the test administration method of FIG. 5;

FIG. 7 is a schematic depiction of gaze point detection according to a particular embodiment which may be used with any of the quality control systems and methods described herein.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Embodiments of the presently disclosed invention may be used in conjunction with any suitable computer-based testing system, unit, device, or method. Non limiting examples of such computer-based testing can be found within the following: U.S. Pat. No. 5,513,994 issued to Kershaw et al. on May 7, 1996, entitled “Centralized System and Method for Administering Computer Based Tests;” U.S. Pat. No. 5,565,316 issued to Kershaw et al. on Oct. 15, 1996, entitled “System and Method for Computer Based Testing;” U.S. Pat. No. 5,872,070 issued to Kershaw et al. on Oct. 27, 1998, entitled “System and Methods for Computer Based Testing;” U.S. Pat. No. 7,784,045 issued to Bowers on Aug. 24, 2010, entitled “Method and System for Computer Based Testing Using an Amalgamated Resource File;” and U.S. Pat. No. 7,828,551 issued to Bowers on Nov. 9, 2010, entitled “Method and System for Computer Based Testing Using Customizable Templates.” The foregoing patent documents are incorporate herein by reference in their entireties.

Although the present discussion and the appended claims are drafted so as to include a human test subject (i.e., test subject 170), the presently disclosed invention need not be limited thereto. Additional computer-based tests may be used such that a non-human agent is performing the tasks being monitored, whereby quality-control procedures are invoked to assure that the non-human agent is performing to applicable standards. The term “test subject” as used herein shall be construed so as to include such non-human agents whose performance is being monitored by computer-based tests. Non-limiting examples of non-human agents include animals, robotic systems, computer systems, mechanical systems, and/or the like.

Some embodiments of the invention may be practiced in conjunction with computer-based tests in which performance monitoring may be achieved through audio, visual, or audiovisual data collection, including but not limited to cognitive, neurobehavioral, psychological, and/or physiological tests administered by computer. References to computer-based test(s) herein should be understood to refer to any such test. Particular embodiments of the presently disclosed invention focus on computer-based tests that specifically measure physiological traits or attributes of one or more test subjects. One example of such a physiological attribute is a fatigue (or, conversely, alertness) level of the test subject. A multitude of computer-based fatigue/alertness testing mechanisms are well known. Particular embodiments of the presently disclosed invention may be used in conjunction with any suitable computer-based fatigue/alertness tests and/or may be sufficiently adaptable to be used in conjunction with many or all of such computer-based fatigue/alertness tests. Non-limiting examples of computer-based fatigue/alertness tests include: tests that measure objective reaction-time tasks and cognitive tasks such as: the Psychomotor Vigilance Task (PVT) or variations thereof (see Dinges, D. F. and Powell, J. W. “Microcomputer analyses of performance on a portable, simple visual RT task during sustained operations,” Behavior Research Methods, Instruments, & Computers 17(6): 652-655, 1985)); a Digit Symbol Substitution Test or variations thereof (see Banks S., et al “Neurobehavioral dynamics following chronic sleep restriction: Dose-response effects of one night of recovery,” Sleep 2010; 33: 1013-26); Motor Praxis Test (MPraxis) or variations thereof (see Gur, R. C. et al. “Computerized neurocognitive scanning: I. Methodology and validation in healthy people,” Neuropsychopharmacology 2001; 25: 766-76); Visual Object Learning Test (VOLT) (see Glahn D. C. et al. “Reliability, performance characteristics, construct validity, and an initial clinical application of a visual object learning test (VOLT),” Neuropsychology 1997; 11:602-12); Fractal-2-Back (F2B) or variations thereof (see Ragland J. D. et al. “Working memory for complex figures: and fMRI comparison of letter and fractal n-back tasks,” Neuropsychology 2002; 16:370-9); Conditional Exclusion Task (CET) or variations thereof (see Kurtz M. M. et al. “The Penn Conditional Exclusion Test (PCET): relationship to the Wisconsin Card Sorting Test and work function in patients with schizophrenia,” Schizophr. Res. 2004; 68:95-102); Matrix Reasoning Task (MRsT) or variations thereof (see Perfetti B. et al. “Differential patterns of cortical activation as a function of fluid reasoning complexity,” Hum. Brain Mapp. 2009; 30:497-510); Line Orientation Test (LOT) or variations thereof (see Benton A. L. et al. “Visuospatial Judgment-Clinical Test,” Neurology 1978; 35: 364-67); Emotion Recognition Task (ER) or variations thereof (see Gur R. C. et al. “Brain activation during facial emotion processing,” Neuroimage 2002; 16:651-62); Balloon Analog Risk Task (BART) or variations thereof (see Lejuez C. W et al. “Evaluation of a behavioral measure of risk taking: The Balloon Analogue Risk Task (BART),” J. of Exp. Psych.-Applied 2002; 8:75-84); Forward Digit Span (FDS) or variations thereof; Reverse Digit Span (BDS) or variations thereof; Serial Addition and Subtraction Task (SAST) or variations thereof; Stroop Test or variations thereof (see,

Go/NoGo Task or variations thereof; Word-Pair Memory Task (Learning, Recall) or variations thereof; Word Recall Test (Learning, Recall) or variations thereof; Motor Skill Learning Task (Learning, Recall) or variations thereof; Threat Detect Task or variations thereof; and Descending Subtraction Task (DST) or variations thereof. All of the publications referred to in this paragraph are hereby incorporated by reference herein.

Particular embodiments of the present invention generally augment the delivery and analysis of computer-based tests with systems and methods for providing quality control though test-subject identity confirmation and/or detection (and possible identification) of testing anomalies.

In this description, the terms “testing anomaly,” “anomaly,” and “testing anomaly event” are used interchangeably to refer to the occurrence of one or more events which may reduce the signal to noise ratio of a statistic associated with test performance or tend to indicate that reliability of the results of a computer-based test has been compromised. Testing anomalies may comprise one or more of: distraction events which tend to divert the test subject's attention away from the task of performing the test and thereby reduce the signal to noise ratio of a statistic associated with test performance or call into question the reliability of the test results; non-compliance events which indicate that there is a violation of one or more protocols (e.g. rules) associated with test and thereby reduce the signal to noise ratio of a statistic associated with test performance or call into question the reliability of the test results; and/or the like. By way of non-limiting example, distraction events may include: sound-based distraction events, such as someone speaking in the background, a radio or MP3 player playing music or other sounds, a cell phone ringing, a siren going off, an alarm going off, a book falling, a door opening, and/or the like; and visual-based distraction events, such as a change in the ambient lighting of the test environment, a flash going off, the test environment experiencing a power outage turning the environment dark, a window or door opening to reveal a bright light source, lightning strikes near a window in the environment, an alarm going off, a television on in the field of view and/or the like. By way of non-limiting example, non-compliance events may include: violation of any test rule; removal of a test subject's finger from a test input device; glancing away from the computer or at the computer of another test subject; movement of the test subject's body away from the test system; and/or the like.

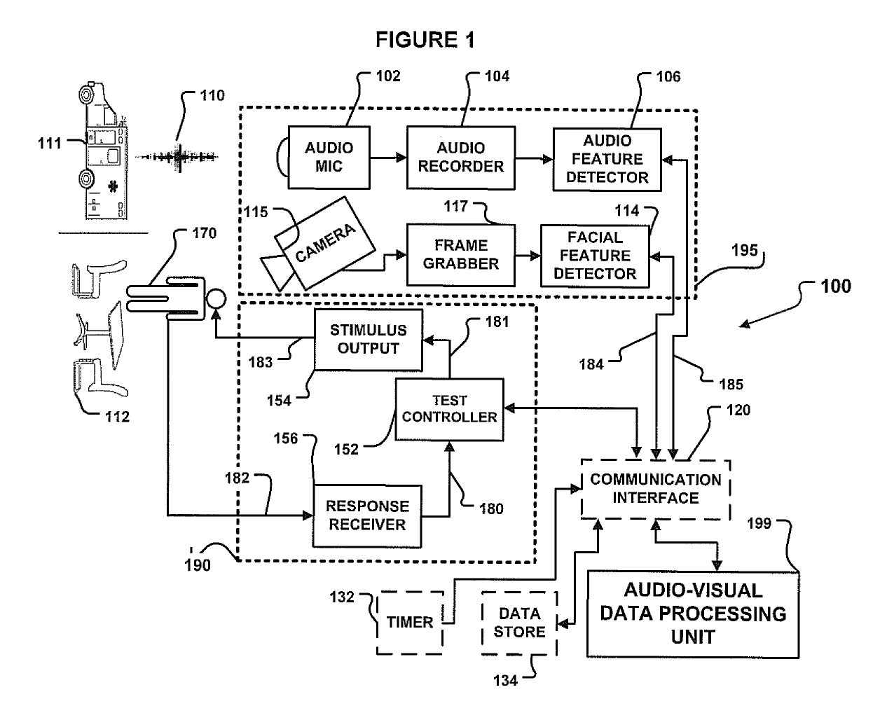

Particular embodiments of the invention provide quality-control systems and methods used in conjunction with computer-based testing systems that generate stimuli and record responses from a test subject. While there may be many variations of such computer-based testing systems, for illustrative purposes this description will focus on one non-limiting exemplary embodiment where quality-control systems and methods are used in conjunction with test system 100, shown schematically in FIG. 1. Test system 100 comprises a test administration unit 190, an audiovisual collection unit 195, and an audio-visual processing unit 199. FIG. 1 also shows a test subject 170, a testing environment 112, a testing anomaly event 111 (in the form of an ambulance passing by testing environment 112), and an audiovisual signal 110 indicative of the existence of testing anomaly event 111. In the particular case of the FIG. 1 illustration, testing anomaly event 111 comprises a distraction event in the form of a soundwave emanating from the ambulance's siren).

Test administration unit 190 is the component of test system 100 that administers the computer-based test to test subject 170. In the illustrated embodiment, test administration 190 comprises a test controller 152 for controlling the administration of a computer-based test to test subject 170, a stimulus output unit 154 for delivering test stimulus to test subject 170, and a response receiver 156, for receiving the test response of test subject 170. In one embodiment, while administering a test, the test controller 152 sends a control signal 181 to the stimulus output unit 154 causing stimulus output unit 154 to generate a stimulus 183. Test subject 170 may generate a corresponding response 182 that may be received by response receiver 156. Response receiver 156 may, in turn, send a response-receiver signal 180 to the test controller 152. In various embodiments, test administration unit 190 may comprise suitable signal processing components known to those skilled in the art. By way of non-limiting example, such signal processing components may comprise: amplifiers, buffers, filters, analog-to-digital converters, digital-to-analog converters, logical components, and/or the like.

Test controller 152 may record various properties of the stimulus and response sequence. For example, in some embodiments, test controller 152 may record the times at which stimuli 183 were provided by stimulus output unit 154 to test subject 170 and at which response 182 was provided by test subject 170 to response receiver 156. In some tests, the speed of response of test subject 170 (i.e., the time between stimulus 183 and response 182) may be a significant outcome variable of the computer-based test, and therefore continuous attention of test subject 170 to the test's stimuli 183 may be desirable. In systems where stimulus output unit 154 comprises a visual display—such as a computer monitor, mobile device screen, wearable device display, diode array, and/or the like—or stimulus output unit 154 otherwise provides visual stimulus 183, then, to detect the stimulus 183 test subject 170 should have a head and eye orientation that allows visual observation of the visual stimulus 183. It may be desirable to detect when the attention of test subject 170 is diverted from visual stimulus 183. Additionally, distracting conditions 111 in test environment 112, some of which may be correlated with auditory sounds, others of which may be correlated to visual events, and yet still others may be correlated to disturbances of other varieties (e.g., distracting smells, test subject 170 being touched by a something, a vibration in the testing environment 112 and/or the like, may also cause unwanted lapses of concentration of test subject 170 on stimulus 183. It may therefore be desirable to detect these types of distraction events. It may also be desirable to verify the identity of test-subject 170 using one or more identification procedures to ensure that test subject 170 is the person whom he or she claims to be.

Audiovisual collection unit 195 may comprise a camera 115 for capturing image and/or video data, an optional frame grabber 117 for extracting frames from video data (in the case where camera 115 is a video camera), a facial feature detector 114 for detecting facial features from within the frames of video data output by frame grabber 117 or the images output by camera 115, an audio microphone 102 for capturing audio data, an audio recorder 104 for recording audio data captured by microphone 102, and an audio feature detector 106 for detecting features from within recorded audio data. In particular embodiments, audiovisual unit 195 or, more particularly, camera 115 may be positioned and/or oriented to record the face of test subject 170 and pass image data which includes the face of test subject 170 to facial feature detector 114 Frame grabber 117, where present, may be configured to capture images from camera 115 and pass such images to a facial-feature detector 114. Non-limiting examples of a suitable camera 115 include a miniature external video camera (“webcam”), a video camera integrated into a computer monitor enclosure, an external digital still camera, specialized camera configurations used in the detection of gaze angle, and/or the like. Frame grabber 117 may comprise any suitable device, system, and/or method for isolating particular images from a video stream, such as, but not limited to, any commercially available software or hardware tool used for such purposes, whether integrated into camera 115 or not. Facial feature detector 114 may locate human faces in an image (e.g., an image detected by camera 115 or isolated by frame grabber 117) and detect gaze orientation of the head and/or pupils of test subject 170. Two-dimensional (2D) information (tracking single points, edges, shading and optical flow) may be extracted from captured image data, and then the 2D information may be translated to a form that could be used for dynamically tracking the three-dimensional (3D) orientation and position of the face of test subject 170, and/or one or more parameters that describe the movement of facial features, such as eyebrows, lips, the mouth, and/or the like.

Non-limiting illustrative examples facial recognition include the following: adaptive overlapping subspaces (Dynamic Tracking of Facial Expressions using Adaptive, Overlapping Subspaces, Dimitris N. Metaxas, Atul Kanaujia, Zhiguo Li ICCS 2007); U.S. Pat. No. 6,108,437 issued to Lin on Aug. 22, 2000, entitled “Face Recognition Apparatus, Method, System and Computer Readable Medium Thereof;” U.S. Pat. No. 6,996,257 issued to Wang on Feb. 7, 2006, entitled “Method for Lighting and View Angle Invariant Face Description with First and Second Order Eigenfunctions;” U.S. Pat. No. 7,139,738 issued to Philomin et al. on Nov. 21, 2006, entitled “Face Recognition Using Evolutionary Algorithms;” U.S. Pat. No. 7,155,037 issued to Nagai et al. on Dec. 26, 2006, entitled “Face Recognition Apparatus;” U.S. Pat. No. 7,295,687 issued to Kee et al. on Nov. 13, 2007, entitled “Face Recognition Method Using Artificial Neural Network and Apparatus Thereof;” U.S. Pat. No. 7,362,886 issued to Rowe et al. on Apr. 22, 2008, entitled “Age-Based Face Recognition;” U.S. Pat. No. 7,421,098 issued to Bronstein et al. on Sep. 2, 2008, entitled “Facial Recognition and the Open Mouth Problem;” U.S. Pat. No. 7,630,526 issued to Bober et al. on Dec. 8, 2009, entitled “Method and Apparatus for Face Description and Recognition;” U.S. Pat. No. 7,715,595 issued to Kim et al. on May 11, 2010, entitled “System and Method for Iris Identification Using Stereoscopic Face Recognition;” U.S. Pat. No. 7,848,544 issued to Mariani on Dec. 10, 2010, entitled “Robust Face Registration via Multiple Face Prototypes Synthesis;” and U.S. Pat. No. 7,953,278 issued to Sung on May 31, 2011, entitled “Face Recognition Method and Apparatus.” The entirety of each of the references cited in this paragraph is hereby incorporated herein by reference. Those skilled in the art will understand that other facial image processing techniques may be used to detect facial position, facial orientation, gaze angle, movement of facial features, and/or the like.

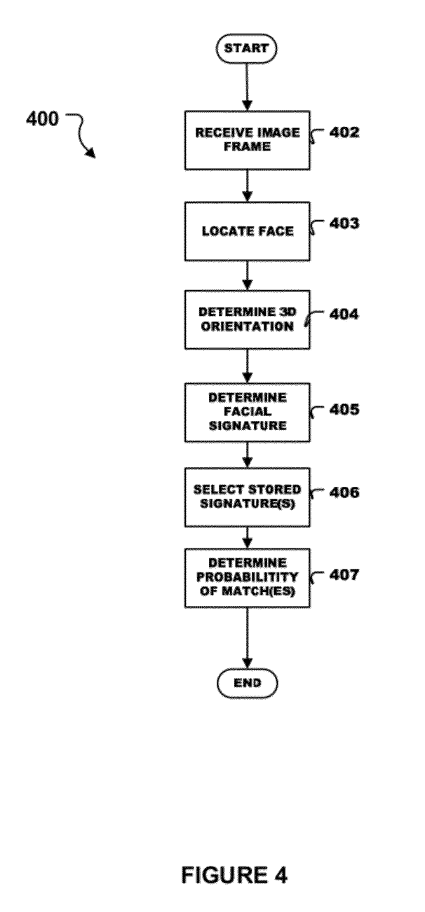

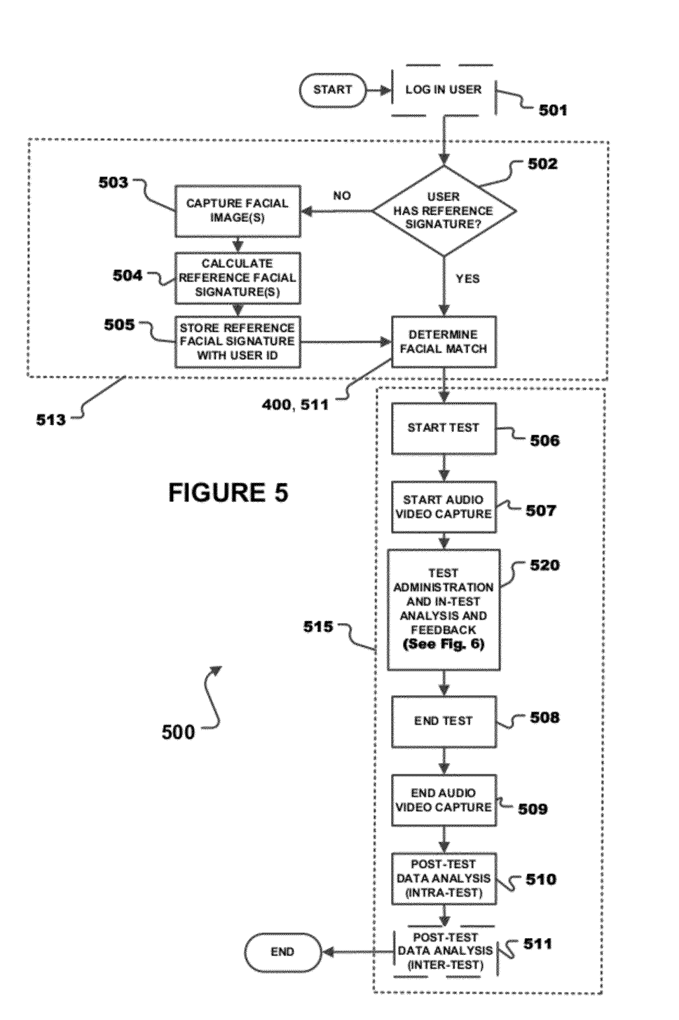

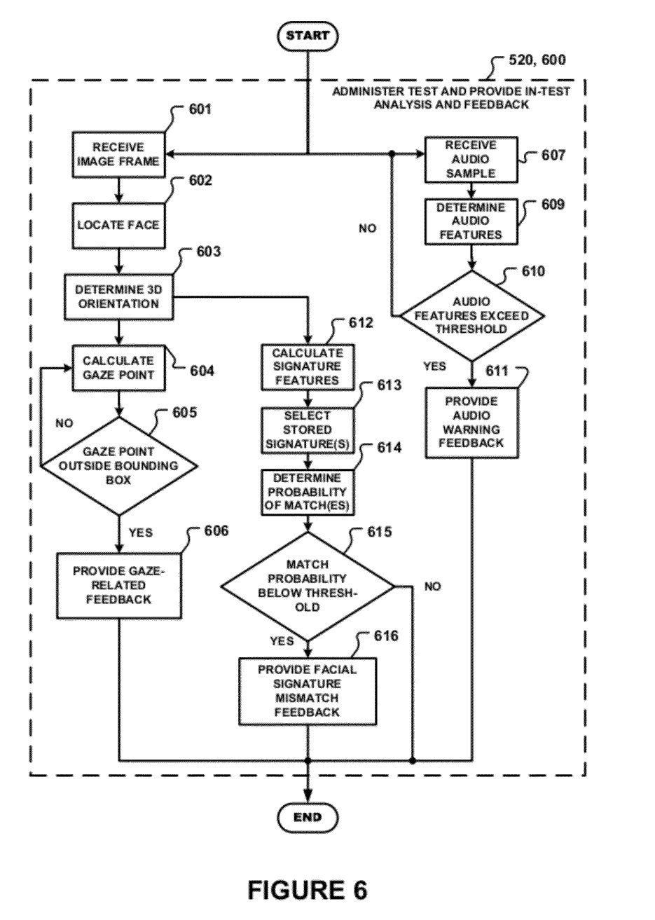

Audio-visual data processing unit 195 may carry out the methods for analyzing audio and visual data described herein, including but not limited to method 400 (FIG. 4), methods 500, 513, and 515 (FIG. 5), and method 600 (FIG. 6), as more fully set forth below.

Lapses in concentration (or any other gaps in stimulus observation, whatever the cause) by test subject 170 may be detected by geometrical analysis of the gaze orientation of test subject 170 relative to stimulus output unit 154. Additionally known facial recognition algorithms may be used to determine one or more facial feature signatures of test subject 170. A facial signature is a set of information that describes one or more facial characteristics that may be used to identify an individual (e.g., test subject 170).

Several algorithms have emerged for producing a digital facial signature from video or photographic images of human faces. These signatures are much like a fingerprint: they are unique to individuals; they are relatively small so they are efficient; and, they may be used in databases to look up the identity and other data about the person. Among such algorithms, one non-limiting example of currently available facial recognition software measures a face according to its peaks and valleys—such as the tip of the nose, the depth of the eye sockets, etc.—which are known as nodal points. A typical human face has 80 nodal points, and precise recognition can be achieved with as few as 14 to 22 utilizing this technique. Specifically, the algorithm concentrates on the inner region of the face, which runs from temple to temple and just over the lip, called the ‘golden triangle.’ This is the most stable because even if facial hair such as a beard is altered, or if the subject changes or adds glasses, changes in weight or ages substantially the ‘golden triangle’ region tends not to be affected, while places such as under chin would be substantially altered. Plots of the relative positions of these points are then converted to long string of numbers, called a faceprint. See U.S. Pat. No. 7,634,662 issued to Monroe on Dec. 15, 2009, entitled “Method for Incorporating Facial Recognition Technology in a Multimedia Surveilance System,” col. 2, line 55 to col. 3, line 3. A slightly different technique compares faces to 128 archetypes it has on record. Faces are then assigned numbers according to how they are similar or different from these archetype models. Id. col. 3, line 4 to col. 3, line 6. Another non-limiting exemplary method subjects a frontal face image (a so-called “mugshot”) to a Fourier Transform from the spatial to the frequency domains to create basis vectors used for comparisons of normalized mugshots. See U.S. Pat. No. 7,564,994 issued to Steinberg et al. on Jul. 21, 2009, entitled “Classification System for Consumer Digital Images Using Automatic Workflow and Face Detection and Recognition.” These and other techniques, as are known in the art and/or as otherwise cited herein, may be implemented using facial feature detector 114 in conjunction with frame grabber 117 and audio-visual data processing unit 199. The entireties of each reference referred to in this paragraph are hereby incorporated herein by reference.

One or more facial signatures of test subject 170 may be recorded for future comparison purposes, or may be compared against one or more previously stored facial signatures to determine match likelihood. A facial image processing algorithm may also detect a stress level of test subject 170, one or more emotional expressions of test subject 170, and/or one or more facial indices of fatigue of test subject 170 using changes in the mouth and eyebrow regions of the face of test subject 170.

One illustrative example of a facial index of fatigue involves the analysis of eyelid closures, as described for example by PerCLOS (terminologically a portmanteau of “percentage” and “closure”) relating to technology that measures the proportion of time subjects have slow eye closure. See Dinges, D. F. et al., “Evaluation of techniques for ocular measurement as an index of fatigue and as the basis for alertness management,” Washington, D. C. 1998, Final report for the USDOT; Dinges, D. F. et al, “Cumulative sleepiness, mood disturbance, and psychomotor vigilance performance decrements during a week of sleep restricted to 4-5 hours per night;” Sleep 20(4), 267-277 (1997); “PERCLOS: A Valid Psychophysiological Measure of Alertness as Assessed by Psychomotor Vigilance,” Fed. Highway Admin. Pub. No. FHWA-MCRT-98-006 (October 1998) (researcher: Dinges, D. F.); Dinges, D. F., et al. “Pilot tests of fatigue management and technologies,” Journal of the Research Transportation Board, No. 1922, pp. 175-182 (2005). The references cited in the foregoing paragraph are hereby incorporated herein by reference in their entireties.

Facial-feature signals 184 from facial feature detector 114 may optionally be communicated to other components test system 100 through optional communications interface 120. Test controller 152 may receive facial-feature signals 184 from facial-feature detector 114 and may utilize facial feature information contained within facial-feature signals 184 to modify stimulus 183 presented to test-subject 170. By way of non-limiting example, test controller 152 may use such facial-feature information: to provide a warning to test subject 170 if his or her gaze orientation exceeds thresholds (e.g., threshold differences between a current gaze orientation and a gaze orientation corresponding to stimulus input unit 154), which thresholds may be configurable parameters of test system 100; to present a log-in verification that indicates if a test subject 170 matches a previously stored facial signature; and/or the like.

An audio microphone 102 may be used as part of test system 100. In some embodiments, audio microphone 102 has acoustic properties and/or positioning relative to test subject 170 that enable audio microphone 102 to capture external sounds, such as a noise 110 associated with a testing anomaly event 111. An audio recorder 104 may optionally record the audio signals from microphone 102 and pass them to an audio feature detector 106. In some embodiments, audio feature detector 106 analyzes audio signals output from microphone 102 and optionally recorded by audio recorder 104 for one or more audio characteristics indicating noise or other events that may be correlated to a potential testing anomaly event 111 for test subject 170. Non-limiting examples of types of testing anomaly events 111, which may be detected by audio feature detector 106, include: other people speaking, movement of physical objects such as a falling item or a door opening, loud background noise such as vehicle engines and/or the like. Audio characteristics associated with these events, which may be detected by audio feature detector 106, include, by way of non-limiting example, rapid changes in audio amplitude (e.g., changes greater than suitable thresholds, which may be configurable parameters of test system 100), high levels of audio amplitude (e.g., audio amplitude levels greater than suitable thresholds, which may be configurable parameters of test system 100), readily identifiable Fourier (frequency) domain characteristics, and/or the like. Audio feature detector 106 may employ a variety of systems and algorithms to detect the occurrence of such audio characteristics. Non-limiting examples of such systems and algorithms include those described within: U.S. Pat. No. 5,689,442 issued to Swanson et al. on Nov. 18, 1997, entitled “Event Surveillance System;” U.S. Pat. No. 6,636,256 issued to Passman et al. on Oct. 21, 2003, entitled “Video Communication System;” U.S. Pat. No. 7,251,334 issued to Sundberg on Jul. 31, 2007, entitled “Remote Sound Monitor and Receiver Therefore;” U.S. Pat. No. 5,515,029 issued to Zhevelev et al. on May 7, 1996, entitled “Glass breakage detector;” U.S. Pat. No. 5,973,998 issued to Showen et al. on Oct. 26, 1999, entitled “Automatic Real-Time Gunshot Locator and Display System;” U.S. Pat. No. 6,690,618 issued to Tomasi et al. on Feb. 10, 2004, entitled “Method and Apparatus for Approximating a Source Positin of a Sound-Causing Event for Determining an Input Used in Operating an Electronic Device;”U.S. Pat. No. 7,234,340 issued to Wen et al. on Jun. 26, 2007, entitled “Apparatus, Method, and Medium for Detecting and Discriminating Impact Sound;” U.S. Pat. No. 7,362,654 issued to Bitton on Apr. 22, 2008, entitled “System and a Method for Detecting the Direction of Arrival of a Sound Signal;” U.S. Pat. No. 7,492,908 issued to Griesinger on Feb. 17, 2009, entitled “Sound Localization System Based on Analysis of the Sound Field;” U.S. Pat. No. 7,499,553 issued to Griesinger on Mar. 3, 2009, entitled “Sound Event Detector System;” U.S. Pat. No. 7,567,676 issued to Griesinger on Jul. 28, 2009, entitled “Sound Event Detection and Localization System Using Power Analysis;” and U.S. Pat. No. 7,680,283 issued to Eskildsen on Mar. 16, 2010, entitled “Method and System for Detecting a Predetermined Sound Event Such as the Sound of Breaking Glass.” Each of the foregoing of references set out within this paragraph is hereby incorporated herein in its entirety. It will also be understood by those skilled in the art, that a variety of these or other techniques may be used to detect audio characteristics, which may be indicative of testing anomaly events 111, such as changes in audio level or audio amplitude levels.

Audio feature signal 185 output from audio feature detector 106 may be communicated to other components of the system though a data bus 120. Test controller 152 may receive audio feature signal 185 from audio feature detector 106 and may utilize audio features contained within audio feature signal 106 to modify stimulus 183 presented to test subject 170. By way of non-limiting example, test controller 152 may use such audio feature information to provide a warning to test subject 170 if audio feature signal 185 is indicative of a testing anomaly event.

A data store 134 may record data from facial feature signal 184 output by facial feature detector 114 and data from audio feature signal 185 output by audio feature detector 106. Non-limiting examples of data that may be stored by data store 134 include raw data (e.g., audio files or video files) passed directly through the various detectors of system 100 (e.g., camera 110, microphone 102, and/or response receiver 156), detected features such as gaze orientation or facial signatures or audio events, and/or warning events in which thresholds were exceeded or there was a facial mismatch. In some embodiments time stamps may also be recorded in data store 134 and may be associated with particular recorded data, recorded features, and/or recorded warning events. Timing data associated with such time stamps may come from optional timing unit 132.

External communication interface 120 may be used to send test data, audio feature data, video feature data, and/or the like to other systems. External communication interface 120 may be also used to retrieve information, such as a reference facial signature, from other systems. Non-limiting examples of external communication interfaces that may be suitable for communication interface 120 include wired and/or wireless network interfaces, an Internet connection, a local area network transceiver, a personal area network transceiver, a Bluetooth® transceiver, an Ethernet card, a modem, and/or the like.

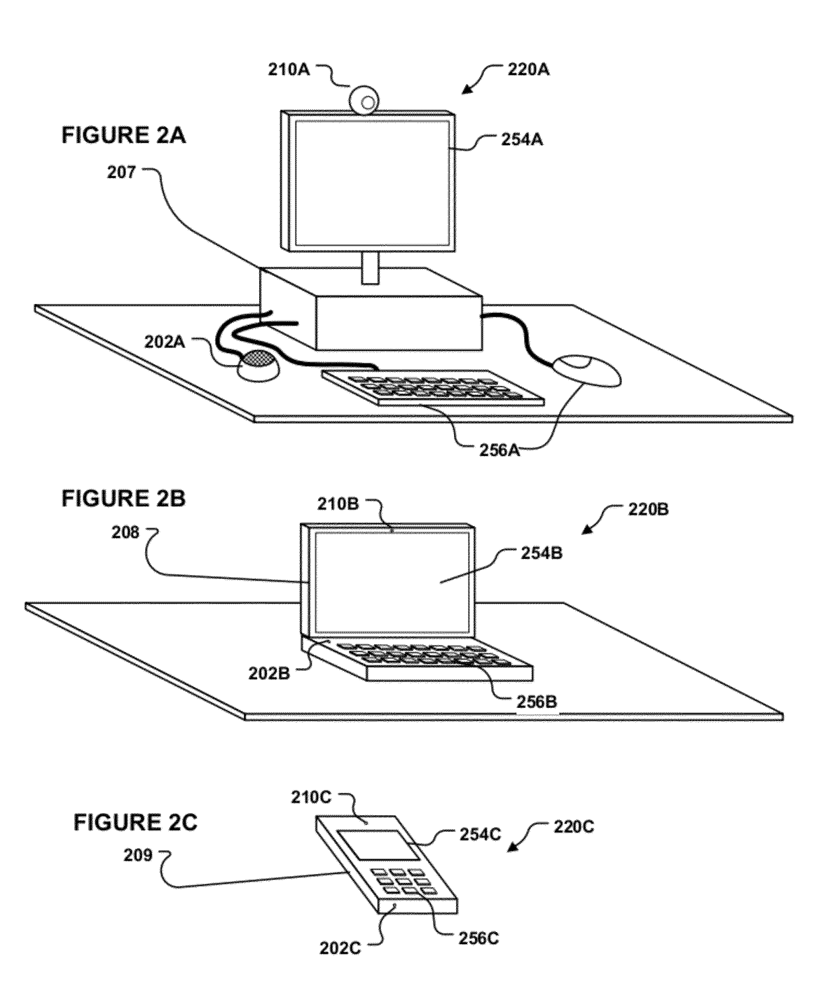

FIGS. 2A, 2B, 2C show various non-limiting exemplary embodiments of test systems with audio and video quality control. More particularly, FIG. 2A shows a test system 220A that includes: a desktop computer 207 with a monitor 254A serving as stimulus output unit 154, a keyboard and mouse 256A serving as test response receiver 156, a standalone camera 210A mounted on monitor 254A serving as camera 115, and an audio microphone 202A, which may optionally be a stand-alone unit (shown) or integrated into one or more other of the foregoing components (not shown), serving as audio microphone 102.

FIG. 2B shows a test system 220B according to another embodiment. Test system 220B of the FIG. 2B embodiment comprises: a laptop computer 208 with an integrated screen 254B and keyboard 256B serving as stimulus output unit 154 and response receiver 156, respectively, and a video camera 210B and audio microphone 202B integrated in laptop computer 208 and serving as camera 115 and audio microphone 102. FIG. 2C shows a test system 220C according to yet another embodiment. Test system 220C of the FIG. 2C embodiment comprises: a handheld computer 209 with an integrated display screen 254C acting as stimulus output unit 154, button input 256C acting as response receiver 156, audio microphone 202C serving as audio microphone 102, and video camera 210C serving as camera 115.

The exemplary embodiments shown schematically in FIGS. 2A, 2B, 2C represent non-limiting examples of hardware which may be used to provide test system 100 (FIG. 1). It will be appreciated that some functionality of systems 220A, 220B, 220C may be implemented using additional or alternative hardware components. By way of non-limiting example, different hardware components may be used to provide the functionality of stimulus output unit 154 and/or response receiver 156. It will be further appreciated by those skilled in the art that computers 207, 208, 209 of systems 220A, 220B, 220C may comprises processing units and the like and corresponding operating systems on which suitable software may be executed to perform some of the functionality of test system 100 described herein. By way of non-limiting example, computers 207, 208, 209 of systems 220A, 220B, 220C may execute software which may implement the audio feature detection of audio feature detector 106, the video feature detection of facial feature detector 114 and/or the like.

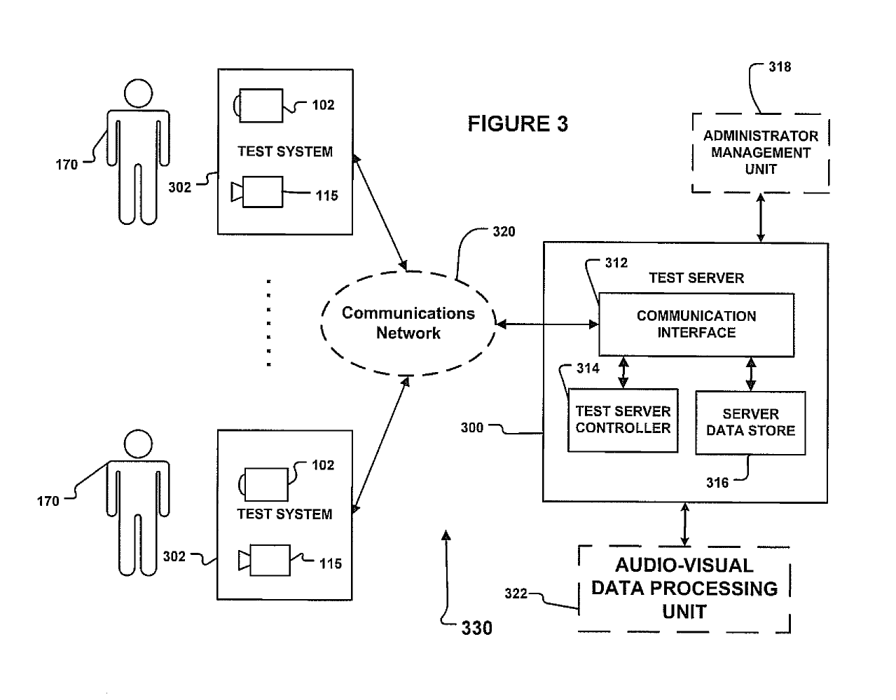

FIG. 3 schematically depicts a test system 330 according to a particular embodiment, where one or more quality control-enabled test systems 302, which may optionally have an audio microphone 102 and a video camera 115, may be operationally connected through communication interface 312 to a test server 300, optionally via a computer network 320 such as a local-area network (LAN), such as an intranet, and/or a wide-area network (WAN) such as the Internet, and/or the like. In the illustrated example embodiment of FIG. 3, test server 300 comprises communication interface 312, a server data store 316 and a test server controller 314. In the overall test system 330 of the FIG. 3 embodiment, test system 302 may save data from its locally administered tests in some combination to its local data store, or to server data store 316. Additionally, each individual test system 302 may query server data store 316 to retrieve data such as IDs for test subject(s) 170, or facial signatures. Audio-visual data processing unit 322 may optionally be situated at a remote location across communications network 320 (as shown in FIG. 3) when combined within test system 330 instead located proximately to test administration unit 190 and audiovisual collection unit 195 within test system 100 (as shown in FIG. 1). In this fashion, processing steps associated with audiovisual data (e.g. all or part of method 400 of FIG. 4; all or part of block 513 and blocks 510, 511, 520 of FIG. 5; and all or part of method 600 of FIG. 6) may be performed remotely or online. Additionally, multiple individual test systems 302 may be connected to test server 300 as shown in the illustrated embodiment. Centralized data storage 316 in test server 300 may be used advantageously by allowing test subject(s) 170 and/or suitable test administrators (not shown) to operate multiple individual test systems 302 simultaneously while retaining access to recent records such as saved facial signatures or test history when performing a test. In some embodiments, individual test systems 302 may send only de-identified data to test server 300. Non-limiting examples of de-identified data include: audio features that do not allow interpretation of intelligible speech, facial signatures that do not allow reconstruction of identifiable facial features, and encryption of data. Non-limiting examples of systems and methods to de-identify data include but are not limited to systems and methods disclosed within the following references: U.S. Pat. No. 6,732,113 issued to Ober et al. on May 4, 2004, entitled “System and Method for Generating De-Identified Health Care Data;” U.S. Pat. No. 7,158,979 issued to Iverson et al. on Jan. 2, 2007, entitled “System and Method of Deidentifying Data;” U.S. Pat. No. 7,376,677, issued to Ober et al. on May 20, 2008, entitled “System and Method for Generating De-Identified Health Care Data;” U.S. Pat. No. 7,519,591 issued to Landi et al. on Apr. 14, 2009, entitled “Systems and Methods for Encryption-Based De-Identification of Protected Health Information;” U.S. Pat. No. 7,668,820 issued to Zuleba on Feb. 23, 2010, entitled “Method for Linking De-Identified Patients Using Encrypted and Unencrypted Demographic and Healthcare Information from Multiple Data Sources;” U.S. Pat. No. 7,711,749 issued to Brodie et al. on May 4, 2010, entitled “Privacy Ontology for Identifying and Classifying Personally Identifiable Information and a Related GUI;” U.S. Pat. No. 7,865,376 issued to Ober et al. on Jan. 4, 2011, entitled “System and Method for Generating De-Identified Health Care Data.” Each of the foregoing of references set out within this paragraph is hereby incorporated herein in its entirety.

FIG. 4 shows a method 400 for determining a facial match as part of a computer-based test according to a particular embodiment. Method 400 may be run on audio-visual data processing unit 199 (FIG. 1) or 322 (FIG. 3) and may utilize the output of camera 115, frame grabber 117 and/or facial feature detector 114. An image frame is first received in block 402, which may involve capturing image data using camera 115 (FIG. 1), and, where applicable, grabbing one or more individual image frames using frame grabber 117 in accordance with the systems and methods discussed previously. A human face is then located in the frame in block 403. Methods for detecting a human face in a photographic frame are known in the art and have been cited and incorporated by reference herein. (See, e.g., U.S. Pat. Nos. 6,108,437 and 7,139,738, among other references, cited above.)

A three-dimensional orientation of the face is then determined in block 404. Well known algorithms, such as those cited and/or described above, using recognition of facial landmarks and/or applying geometric analysis may be used to determine the 3D orientation in block 404. (See, e.g., U.S. Pat. Nos. 7,484,544 and 7,564,994, among other references, cited above.).

A facial signature may be determined in block 405 based upon facial landmarks or other processing techniques. Facial-signature detection techniques are also well known in the art, and any suitable technique may be used by the presently disclosed invention. See, e.g., U.S. Patent App. No. 2011/0026778 published Feb. 3, 2011, entitled “System and Method of Using Facial Recognition to Update a Personal Contact List,” the entirety of which is hereby incorporated by reference.

One or more stored or otherwise previously obtained facial signatures may be selected in block 406 for comparison to the current facial signature. The stored facial signatures may be stored in a local machine or remotely on a server—e.g., data server store 316 of test server 300 (FIG. 3) and/or the like. Methods for carrying out the block 406 selection of facial signatures may include any suitable method or algorithm for identifying one or more facial signatures stored in a data store such as data server store 316 or on a computing device such as test server 300. A comparison of the block 405 facial signature determined from the current block 402 image frame may then be compared to the one or more stored or otherwise previously obtained facial signatures, within block 407, in order to determine the identity of test subject 170. Systems and methods for verifying identity of human subjects by comparing facial signatures are also well known in the art, and any suitable technique may be used by the presently disclosed invention. (See, e.g., U.S. Pat. No. 7,155,037, among other references, cited above).

FIG. 5 schematically depicts a method 500 for conducting a test using audio and video quality control according to an example embodiment. Method 500 of the FIG. 5 embodiment is schematically divided into two principal function blocks which include: block 513 which, as explained in more detail below, involves confirmation of the identity of test subject 170; and block 515, which involves administration of a test to test subject 170 once their identity has been confirmed.

Method 500 may commence in block 501, wherein test subject 170 may log in. Block 501 may establish a primary identification of test subject 170. Suitable identification techniques which may be used in block 501 may include, but are not limited to, entry of a username and password pair, selection of a user ID, use of any other suitable identification method, and/or the like. Method 500 then proceeds to identity-verification block 513, which involves confirming that test subject 170 is indeed the person who logged on in block 501. Identity-verification block 513 commences in block 502. Block 502 may involve determining whether the block 501 identified test subject has a suitable (e.g., current and/or at least recently taken) facial reference signature stored and available to the test system for verification purposes. If not, then a new reference image may be captured 503, converted into a facial signature 504, and stored for future reference 505, in accordance with methods described herein, before proceeding to block 511. Block 511 involves determining whether there is a facial signature match between the test subject 170 identified in block 501, and one or more stored facial signatures, which may be stored, for example, in server data store 316. In some embodiments, the block 511 facial match determination may be performed using method 400 (FIG. 4), although this is not necessary. If the test subject 170 identified in block 501 does have a stored facial reference signature (block 502 YES output), then method 500 may proceed directly to the block 511 facial match determination. Results of the block 511 facial match determination may simply be stored for future reference, a warning may be given upon a mismatch, or test subject 170 may be prevented from starting the test (of method 500) if there is a mismatch. The action taken upon discovery of a mismatch in the block 511 facial match determination may be a configurable variable of test system 100. Other variations of the block 511 identification confirmation methods may include fingerprint matching, retinal scanning, identification card scanning, and/or the like.

Method 500 then proceeds to administer a test in block 515. In some embodiments, the block 513 identification confirmation procedure is not necessary and method 500 may proceed directly to the block 515 test administration. The block 515 test administration starts in block 506, which may involve some test initialization. Method 500 then proceeds to block 507, which involves initiating one or more audio and/or video capture devices (see microphone 102 and camera 115 of FIG. 1) may be initiated. The test is administered to test subject 170 in block 520 and data acquired from the audio and/or video capture devices is analyzed to provide in-test feedback about testing anomaly events. The analysis and in-test feedback provided in block 520 are discussed in more detail below. When a test ends, in block 508, any audio and/or video device capture may be turned off, block 509. After completion of the block 515 test, intra-test post-test data analysis may be performed in block 510 or intra-test post-test data analysis may be performed in block 511, which are discussed in more detail below. The post-test data analysis may perform the same analysis as the during-test data analysis, except that the real-time feedback is not performed, or additional analyses may be performed that involve batch processing of the entire data set (rather than real-time processing) or for calculation of results metrics.

One non-limiting example of intra-test post-test analysis 510 may include associating any measurement uncertainties associated with particular test responses to the overall test results (of a single test) when the overall results are derived from timing measurements of testing subject's 170 responses to test stimuli. In the particular non-limiting case of reaction-time tests, including the PVT, the DSST, and/or the like, a testing anomaly event (e.g. a distraction event and/or a non-compliance event) may cause test subject 170 to respond differently (e.g. more slowly or more quicldy) to a test stimulus than he or she otherwise would. One or more delays caused by a testing anomaly may impact the accuracy of any statistical testing metrics derived from slower-than-expected test responses. U.S. Provisional Patent Application No. 61/481,039, the entirety of which is hereby incorporated herein by reference, discloses systems and methods for detecting and measuring latencies within reaction-time test systems and propagating any uncertainty associated with measured response times into specific testing metrics with an associated uncertainty in accordance with error propagation rules. One or more embodiments of the presently disclosed systems and methods are also capable of propagating uncertainties associated with specific measured reaction times, caused by testing anomaly events, into uncertainty associated with statistical metrics derived from such measured response times. Table 1, below, provides a non-limiting example of how measurement uncertainty associated with response times may be propagated, as part of post-test data analysis 510, to overall test metrics on a PVT test (which represents one particular and non-limiting example of a computer-based reaction time test).

| xₙ | The [symbol] PVT measurement (in ms). [xₙ] represents the set of all PVT measurements in the test. | | |
|---|---|---|---|
| uₙ | The error associated with the n^{th} PVT measurement (in ms). | | |
| N | The total number of PVT measurements in the test. Σ represents the sum over n, from n = 1 to n = N. | | |
| N_{V}, N_{L}, N_{F}, N_{C}, N_{N}, N_{H} | The number of: Valid responses, Lapses, False starts, Coincident false starts, No responses, Buttons stuck. | | |
| M | The metric value. | | |
| U | The total uncertainty associated with a metric value. In reporting a metric, it can be written as the metric value plus | | |
| | or minus the metric uncertainty, i.e., as M ± U. | | |
| | METRIC | | |
| METRIC NAME | DESCRIPTION | EQUATION FOR THE METRIC | EQUATION FOR THE METRIC UNCERTAINTY |
| MeanRT (ms) | Mean reaction time | $M = \frac{1}{N} Σ {x}_{n}$ | $U = \frac{1}{N} \sqrt{{Σ ( {u}_{n} )}^{2}}$ |
| MeanRRT | Mean reciprocal of reaction times | $M = \frac{1}{N} Σ \frac{1}{{x}_{n}}$ | $U = \frac{1}{N} \sqrt{Σ \frac{{( {u}_{n} )}^{2}}{{( {x}_{n} )}^{4}}}$ |
| MeanFRT (ms) | Mean of fastest 10% | Same as MeanRT, except for the fastest | Same as MeanRT, except for the fastest 10% of |
| | reaction times | 10% of [xₙ] | [xₙ] |
| Lapses | Total lapse count | M = N [symbol] | See note 1. |
| | (untransformed) | | |
| STDRT (ms) | Standard deviation of RT | Let x̅ be the MeanRT defined above, then $M = \sqrt{\frac{1}{( N - 1 )} {Σ ( {x}_{n} - \overline{x} )}^{2}}$ | $U = \frac{1}{M ( N - 1 )} \sqrt{{Σ [ ( {x}_{n} - \overline{x} ) {u}_{n} ]}^{2}}$ |
| MeanSRT (ms) | Mean of slowest | Same as MeanRT, except for the | Same as MeanRT, except for the slowest 10% of |
| | 10% reaction times | slowest 10% of [xₙ] | [xₙ] |

Note 1:
Calculating the exact uncertainty of the counted quantities (e.g., the number of lapses N [symbol] or the number of coincident false starts N_{C}) is also non-trivlat. One approximate approach as follows. First, calculate the “worst-case” uncertainty by assuming the worst possible measurement errors. For example, if the threshold for calculating N [symbol] is 100 ms, then by definition N_{C} = count (xₙ start that [symbol] ₙ < 100), and we can calculate N [symbol] = count (xₙ such that x [symbol] + n [symbol] < 100), and N [symbol] = count (xₙ such that xₙ - u [symbol] < 100). The worst case uncertainty in N_{C} would thus be given by [symbol] = max(|N [symbol] − N_{C}|, |N [symbol] − N_{C}|). As discussed in Note 1. The correction factor for the case when the errors are uncorrelated can be estimated as 1/\sqrt{N}. Therefore, the final reported uncertainty should be
$U = \frac{1}{\sqrt{n}} {U}_{WC}$ [symbol] indicates data missing or illegible when filed

Optional step 511 comprises analysis of captured quality control data and/or test results from a plurality of test for inter-test quality-control purposes. By way of non-limiting example, inter-test data analysis in block 511 may include: analyzing and/or comparing data acquired from the audio and/or video capture devices for consistency across multiple test administrations within the same or comparable testing environment(s) 112 at the same or different times for consistency of testing conditions; analyzing and/or comparing test results for consistency across multiple test administrations; and/or the like. By way of non-limiting example: light and/or sound levels may be compared across multiple test administrations and, in some embodiments, conclusions may be drawn as to whether such light and/or sound levels may have impacted corresponding test results; the existence of the same or comparable testing anomaly event(s) 111 or different testing anomaly events 111 may be detected across multiple test administrations and, in some embodiments, corresponding test results may be adjusted, annotated, or eliminated accordingly; and/or the like. In some embodiments, the comparison of quality control data and/or test results across the plurality of test administrations may involve identifying an inter-test testing anomaly event in circumstances where the quality control data and/or test results are sufficiently different from one another (e.g. suitable metrics differ from one another by more than corresponding inter-test thresholds). In this fashion any relevant variance across multiple test-administrations (eg. within different testing environments or within the same testing environment at different times) may be considered to be an inter-test testing anomaly event 111.

As discussed above, block 520 of test administration block 515 involves administering a computer-based test, analyzing data acquired from the audio and/or video capture devices and providing in-test feedback in respect of testing anomalies. FIG. 6 depicts a method 600 for providing in-test analysis and feedback in respect of testing anomalies according to a particular embodiment, which may be used as (or as part of) block 520. Method 600 involves administering a test to the test subject 170. The types of suitable tests administered as part of method 600 are discussed in detail above. Such tests may be ongoing during all, or a substantial part of, method 600.

Method 600 involves performing a number of quality control steps which may take place continuously, at particular discrete times or at particular discrete events during administration of the test to test subject 170. Such quality control processing steps, which are described further below, may include, but are not limited to, gaze point analysis, behavioral analysis, facial signature detection, audio distraction detection and/or the like. The illustrated embodiment of method 600 shows an exemplary sequence of possible quality control steps that may be performed, but it should be understood that method 600 of the FIG. 6 embodiment is only exemplary. Not all of the method 600 quality control steps need be performed. Other quality control steps (not shown) may be added to method 600 and/or one or more of the method 600 quality control steps may be varied.

Method 600 of the illustrated embodiment may commence in block 601 which involves receiving an image frame and then proceeds to block 602 which involves locating a face in the block 601 image frame. Block 603 then involves determining a three-dimensional face orientation of the face detected in block 602. A gaze point may then be determined in block 604. Block 605 involves an inquiry as to whether the block 604 gaze point is focused on the test being administered in block 600. For example, block 605 may involve an inquiry into whether the gaze of test subject 170 is directed toward stimulus output device 154 and/or stimulus signal 183 (see FIG. 1). Block 605 may be implemented, in one particular embodiment, by creating a bounding box or similar bounding region and ascertaining whether the block 604 gaze point of test subject 170 is directed to point(s) located within the bounding region. The bounding region used in block 605 may be a configurable parameter of the testing system. If the block 604 gaze point is within the bounding region, then the block 605 inquiry may conclude that test subject 170 is focused on the test.

If, however, the block 604 gaze point is outside of the bounding region, then the block 605 inquiry may conclude that test subject 170 is distracted and method 600 may then proceed to block 606 which involves providing gaze-related feedback. The gaze-related feedback provided in block 606 may take a variety of forms. For example, the block 606 feedback may comprise a warning to test subject 170, a cancellation of the method 600 test, a notation appended to the results of the block 600 test and/or the like.

In the illustrated embodiment, the three-dimensional face orientation determined in block 603 may also be used in block 612 to determine one or more facial signatures corresponding to test subject 170. Block 613 may then involve receiving one or more stored facial signatures (e.g. corresponding to the test subject identified in block 501 (FIG. 5)). Method 600 then proceeds to block 614 which involves determining a probability of matches between the newly obtained block 612 facial signature and the block 613 stored (e.g. previously acquired) facial signatures. Block 615 involves an inquiry as to whether the block 614 probability is within a proximity threshold. The proximity threshold used in block 615 may be a configurable parameter of the testing system. If the block 614 probability is within the proximity threshold, then the block 615 inquiry may conclude that test subject 170 is the same as the test subject identified in block 501 (FIG. 5). On the other hand, if the block 614 probability is outside of the proximity threshold, then the block 615 inquiry may conclude that test subject 170 is not the same person as the one identified in block 501 and method 600 may then proceed to block 616 which involves providing facial-signature-mismatch feedback. The facial-signature-mismatch feedback provided in block 616 may take a variety of forms. For example, the block 616 feedback may comprise a warning to test subject 170, a cancellation of the method 600 test, a modification of the test procedure to include an additional stimulus, a notation appended to the results of the block 600 test and/or the like.

Audio quality control analysis may also be performed as a part of method 600. Block 607 involves receiving an audio sample and block 609 may involve extracting one or more audio features from the block 607 audio sample. Method 600 then proceeds to block 610 which involves an inquiry into whether the block 609 extracted audio features match patterns or are above/below suitably configured audio threshold criteria. Such patterns and audio threshold criteria may comprise configurable parameters of the testing system. Where the block 609 extracted audio feature(s) are not indicative of a testing anomaly (block 610 NO output), then method 600 may conclude that test subject 170 is focused on the test. Where the block 609 extracted audio feature(s) are indicative of a testing anomaly event (block 610 YES) output, then method 600 may proceed to block 611 which may involve providing audio-anomaly feedback. The audio-anomaly feedback provided in block 611 may take a variety of forms. For example, the block 611 audio-anomaly feedback may comprise a warning to test subject 170, a cancellation of the method 600 test, a modification of the test procedure to include an additional stimulus, a notation appended to the results of the block 600 test and/or the like.

Returning to method 500, in some embodiments it may be desirable to perform some quality control analysis as a post-test step (block 510) of FIG. 5. The block 510 post-test quality control analysis may be similar to that described above for block 520 (method 600) except that real-time feedback is not provided and additional analysis may be performed where batch processing of the entire data set may be desirable. Additional variations of method 600 of FIG. 6 may include, by way of non-limiting example, an eyelid closure detection algorithm performed in addition to or instead of gaze angle detection. An eyelid closure analysis algorithm, such as PerCLOS, could also be used to provide an indicator of fatigue. Fatigue levels measured from eyelid closures could then be correlated with other measures determined from the test—such as gaze-point analysis (blocks 604, 605, 606), audio feature analysis (blocks 607, 609, 610, 611)—to detect consistent results with the test's measurements of fatigue, to detect discrepancies, or to adjust results at specific times based on the test subject's observed eyelid closure. As an example of the latter, if an eyelid closure is observed at a time coincident with a delayed response to a test stimulus then the test response could be annotated or have a time correction added. An additional quality control measure that may be performed during or after a test (e.g., as a part of block 520 or blocks 510 or 511) is that adherence to test protocols (i.e. test-compliance analysis) may be performed during administration of the test (block 520) or after administration of the test (block 510). By way of non-limiting example, if response time values are outside expected physiological bounds, or there is no test subject feedback at all, then there is a likelihood of a condition of non-compliance or test deployment failure. In still other embodiments, image data (e.g. from camera 115) may be received and analyzed for features other than test subject identity and gaze orientation. Such analysis of image data may be performed in a manner analogous to that of audio data in blocks 607, 609, 610, 611.

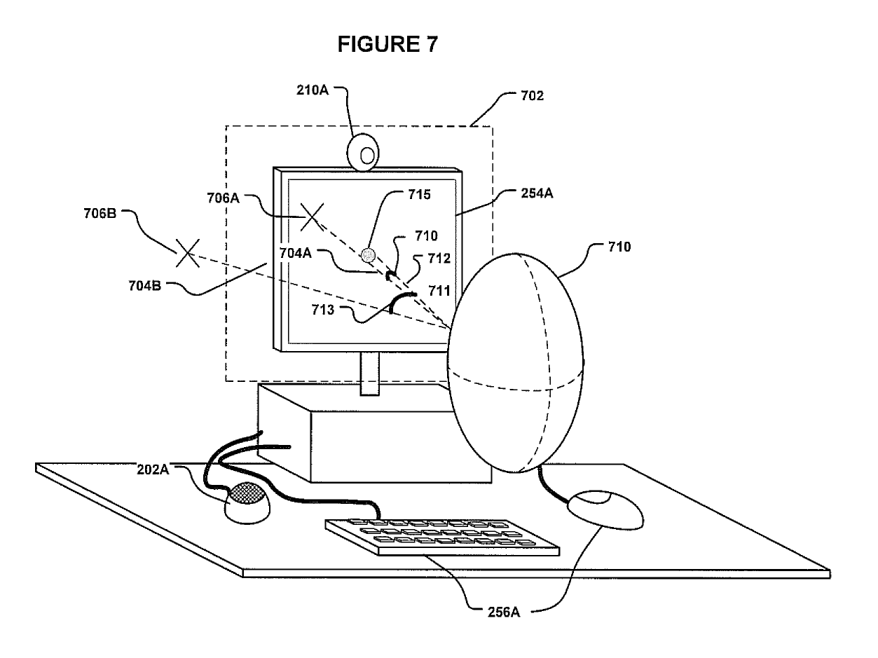

FIG. 7 shows a schematic illustration of gaze angle and bounding box calculation, as practiced in accordance with a particular embodiment of the presently disclosed invention where a test is begin administered on a desktop system 207, as illustrated in FIG. 2B. An oblong spheroidal object representative of a typical placement of a test subject's head 710 is situated in viewing range of monitor 254A. During video feature detection (e.g., block 603 of FIG. 6), the 3D orientation of the head 710 may be calculated to include a range of positions and angular orientations (e.g., pitch, roll, yaw, etc.). A gaze angle 711, 712, comprising two distinct angular coordinates (e.g., angles θ and φ in a spherical coordinate system, not shown, hypothetically centered to coincide with center of head 710 or with one or both of the pupils of the test subject) measured from a reference line 710 (e.g., the reference radius from the aforementioned hypothetical spherical coordinate system) may be geometrically constructed from gaze trajectory 704A, 704B. For convenience reference line 710 may be optionally considered as the radius from head 710 to the geometric center 715 of screen 254A. Gaze angle 711, 712 may be estimated from the head orientation, and may also be estimated with pupil orientation information. Using knowledge of the relative placement of camera 210A and screen 254A in the same positional coordinate system as the gaze trajectory 704A, the intersection point 706A at which gaze trajectory 704A intersects the plane of monitor 254A may be calculated. A bounding box 702, or other bounding region, in the plane of the screen of monitor 254A may be selected as a suitable threshold. If gaze intersection point 706A falls outside bounding box 702 as shown with intersection point 706B then a feedback action may be taken by the test system.

Certain implementations of the invention comprise computer processors which execute software instructions which cause the processors to perform a method of the invention. For example, one or more processors may implement data processing steps in the methods described herein by executing software instructions retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. For example, alertness measurements or state inputs may be delivered over a network, such as a local-area-network, wide-area-network, or the internet, to a computational device that performs individual alertness predictions. Future inputs may also be received over a network with corresponding future alertness distributions sent to one or more recipients over a network. Such a system may enable a distributed team of operational planners and monitored individuals to utilize the information provided by the invention. A networked system may also allow individuals to utilize a graphical interface, printer, or other display device to receive personal alertness predictions and/or recommended future inputs through a remote computational device. Such a system would advantageously minimize the need for local computational devices.

Certain implementations of the invention may comprise exclusive access to the information by the individual subjects. Other implementations may comprise shared information between the subject's employer, commander, flight surgeon, scheduler, or other supervisor or associate, by government, industry, private organization, etc., or any other individual given permitted access.

Certain implementations of the invention may comprise the disclosed systems and methods incorporated as part of a larger system to support rostering, monitoring, diagnosis, epidemiological analysis, selecting or otherwise influencing individuals and/or their environments. Information may be transmitted to human users or to other computer-based systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

It will be apparent to those skilled in the art in the light of the foregoing disclosure, many alterations and modifications are possible in the practice of this invention without departing from the spirit or scope thereof. For example:
The term alertness is used throughout this description. In the field, alertness and performance are often used interchangeably. The concept of alertness as used herein should be understood to include performance and vice versa.
The terms “fatigue” is used in this application to apply generally to any physiological state (including, e.g., sleepiness, intoxication, distraction, mental impairment, and/or the like) that may impact the test subject's performance on the test. The terms sleepiness and fatigue are also herein understood to be interchangeable. However, in certain contexts the terms could be conceptually distinguished (e.g. as relating to cognitive and physical tiredness, respectively). Embodiments thus construed are included in the invention.
The terms “result” or “test result” are used in this application to apply generally to any output of a test, whether referring to a specific user response to a question or stimulus, or whether referring to a statistical analysis or other cumulative processing of a plurality of such user responses. In the case of stimulus-response tests, these terms may refer to the timer interval associated with specific responses to stimuli or to a cumulative metric of such time intervals collected in response to a plurality of stimuli presented throughout a test or portion thereof.
Many mathematical, statistical, and numerical implementations may be used to generate fatigue predictions.
Purely analytical examples or algebraic solutions should be understood to be included.

What is claimed is:

1. A system for controlling quality of a computerized test administered to a human test subject, the system comprising:
a test administration unit for administering the test to the human test subject in a test environment;
an audiovisual data collection unit for collecting quality control data, the quality control data comprising at least one of audio data, image data and video data relating to at least one of the test subject and the test environment; and
an audiovisual processing unit for analyzing the quality control data to detect, from within the quality control data, a testing anomaly event which may indicate that a reliability of results of the test has been compromised;
wherein, in response to a detected testing anomaly event, at least one of the audiovisual processing unit and the test administration unit is configured to adjust at least one of the administration and results of the test.

2. A system according to claim 1 wherein the testing anomaly event comprises one or more of: a distraction event indicating that the test subject may have been distracted while performing the test; and a non-compliance event indicating that the test subject may have violated one or more testing protocols associated with the test.

3. A system according to claim 1 wherein the quality control data comprises quality control audio data.

4. A system according to claim 3 wherein the audiovisual processing unit is configured to detect the testing anomaly event based at least in part on an audio intensity level of the quality control audio data being greater than an audio intensity threshold.

5. A system according to claim 3 wherein the audiovisual processing unit is configured to detect the testing anomaly event based at least in part on a rate of change of audio intensity level of the quality control audio data being greater than an audio intensity rate of change threshold.

6. A system according to claim 1 further comprising a biometric sensor for verifying the identity of the test subject.

7. A system according to claim 3 wherein the audiovisual processing unit is configured to detect the testing anomaly event based at least in part on a rate of change in a frequency spectrum of the quality control audio data being greater than an audio frequency spectrum rate of change threshold.

8. A system according to claim 3 wherein the audiovisual processing unit is configured to detect the testing anomaly event based at least in part on comparing a frequency spectrum of the quality control audio data to frequency spectra of one or more of: known model distraction events, and known model non-compliance events.

9. A system according to claim 8 wherein the known model distraction events comprise speech frequency patterns.

10. A system according to claim 1 wherein the quality control data comprises quality control image data relating to the test subject.

11. A system according to claim 10 wherein the audiovisual processing unit is configured to detect the testing anomaly event based at least in part on a position of one or more parts of the body of the test subject changing within the quality control image data by an amount greater than a body movement threshold.

12. A system according to claim 10 wherein the audiovisual processing unit is configured to detect the testing anomaly event based at least in part on a position of one or more parts of the body of the test subject changing within the quality control image data at a rate greater than a body movement rate of change threshold.

13. A system according to claim 10 wherein the quality control image data comprises image data corresponding to one or more eyes of the test subject, and the audiovisual processing emit is configured to process the quality control image data to estimate a gaze point of the test subject and to detect the testing anomaly event based at least in part on a gaze point of the test subject being outside of a bounding region.

14. A system according to claim 1 wherein the quality control data comprises quality control image data relating to the test environment.

15. A system according to claim 10 wherein the quality control data further comprises quality control image data relating to the test environment.

16. A system according to claim 14 wherein the audiovisual processing unit is configured to detect the testing anomaly event based at least in part on changes in a light level in the test environment being greater than a light level threshold.

17. A system according to claim 14 wherein the audiovisual processing unit establishes thresholds based, at least in part, on environmental measurements collected during previous tests.

18. A system according to claim 14 wherein the audiovisual processing unit is configured to detect the testing anomaly event based at least in part on a position of one or more objects in the test environment changing within the quality control image data by an amount greater than an object movement threshold.

19. A system according to claim 1 wherein the audiovisual processing unit is configured to record a temporal characteristic of the detected testing anomaly event, the temporal characteristic comprising at least one of a time of onset of the detected testing anomaly event and a temporal duration of the detected testing anomaly event.

20. A system according to claim 19 wherein the at least one of the audiovisual processing unit and the test administration unit is configured to adjust the at least one of the administration and the results of the test based at least in part on the temporal characteristic of the detected testing anomaly event.

21. A system according to claim 1 wherein the test administration unit comprises:
a stimulus output device for providing a stimulus to the test subject;
a response receiver for detecting a response of the test subject to the stimulus; and
a test controller for administering a stimulus-response test which involves measurement of time intervals between the provision of stimulus to the test subject and detected responses of the test subject.

22. A system according to claim 21 wherein the at least one of the audiovisual processing unit and the test administration unit is configured to adjust at least one of the measured time intervals between the provision of stimulus to the test subject and detected responses of the test subject in response to the detected testing anomaly event.

23. A system according to claim 22 wherein:
the audiovisual processing unit is configured to record a temporal characteristic of the detected testing anomaly event, the temporal characteristic comprising at least one of a time of onset of the detected testing anomaly event, time of cessation of the detected testing anomaly event, and a temporal duration of the detected testing anomaly event; and
the at least one of the audiovisual processing unit and the test administration unit is configured to adjust the at least one of the measured time intervals based at least in part on the temporal characteristic of the detected testing anomaly event.

24. A system according to claim 21 wherein the stimulus-response test comprises a psychomotor vigilance test.

25. A system according to claim 1 wherein at least one of the test administration unit, the audiovisual data collection unit, and the audiovisual processing unit is distributed across a computer network.

26. A system according to claim 1 wherein the audiovisual data collection unit is configured to collect identity verification data, the identity verification data comprising at least one of audio data, image data and video data relating to the test subject.

27. A system according to claim 26 wherein the audiovisual processing unit is configured to analyze the identity verification data to verify an identity of the test subject.

28. A system according to claim 27 wherein the audiovisual processing unit is configured to perform at least one of:
processing the identity verification data to determine an iris scan signature of the test subject and verifying the identity of the test subject by comparing the iris scan signature of the test subject to one or more previously ascertained iris scan signatures of the test subject;
processing the identity verification data to determine a facial signature of the test subject and verifying the identity of the test subject by comparing the facial signature of the test subject to one or more previously ascertained facial signatures of the test subject; and
processing the identity verification data to determine a voice signature of the test subject and verifying the identity of the test subject by comparing the voice signature of the test subject to one or more previously ascertained voice signatures of the test subject.

29. A system according to claim 1 wherein the at least one of the audiovisual processing unit and the test administration unit is configured to adjust at least one of the administration and results of the test by eliminating one or more of the results in response to a detected testing anomaly event.

30. A system according to claim 1 wherein the at least one of the audiovisual processing unit and the test administration unit is configured to adjust at least one of the administration and results of the test by annotating one or more of the results in response to a detected testing anomaly event.

31. A system according to claim 23 wherein the at least one of the audiovisual processing unit and the test administration unit is configured to adjust at least one of the administration and results of the test by deducting the temporal duration of the testing anomaly event from the measured response time.

32. A system according to claim 24 wherein the at least one of the audiovisual processing unit and the test administration unit is configured to adjust the at least one of the administration and results of the test by eliminating one or more response times from the calculation of a statistical metric of the psychomotor vigilance test if the testing anomaly event temporally coincides with one or more response intervals corresponding to the one or more eliminated response times.

33. A system according to claim 23 wherein the at least one of the audiovisual processing unit and the test administration unit is configured to adjust the at least one of the administration and results of the test by adjusting a calculation of a statistical metric of the test if the testing anomaly event temporally coincides with one or more response intervals.

34. A system according to claim 23 wherein the at least one of the audiovisual processing unit and the test administration unit is configured to adjust the at least one of the administration and results of the test by propagating an uncertainty interval through a calculation of a statistical metric of the test if the testing anomaly event temporally coincides with one or more response intervals.

35. A system according to claim 1 wherein the at least one of the audiovisual processing unit and the test administration unit is configured to adjust the at least one of the administration and results of the test by terminating the test prematurely in response to a testing anomaly event.

36. A system according to claim 1 wherein the at least one of the audiovisual processing unit and the test administration unit is configured to adjust the at least one of the administration and results of the test by temporarily suspending administration of the test in response to a testing anomaly event.

37. A system according to claim 36 wherein the at least one of the audiovisual processing unit and the test administration unit is configured to adjust the at least one of the administration and results of the test by resuming administration of the test only after the testing anomaly event has ended.

38. A system according to claim 1 wherein the at least one of the audiovisual processing unit and the test administration unit is configured to adjust the at least one of the administration and results of the test during the administration of the test, in response to a testing anomaly event.

39. A system according to claim 1 wherein the at least one of the audiovisual processing unit and the test administration unit is configured to adjust the at least one of the administration and results of the test after the administration of the test has ended, in response to a testing anomaly event.

40. A system according to claim 1 further comprising an administrator management unit, wherein an administrator can review the test results including any test results adjusted in response to detection of a testing anomaly event.

41. A system according to claim 1 wherein at least one of the audiovisual processing unit and the test administration unit is configured to compare the quality control data to previously collected quality control data from a previously administered test.

42. A system according to claim 41 wherein at least one of the audiovisual processing unit and the test administration unit is configured, based on the comparison of the quality control data to previously collected quality control data, to perform at least one of: concluding that there is an inter-test testing anomaly event if any metric of the quality control data is different from a corresponding metric of the previously collected quality control data by more than an inter-test threshold; and adjusting test results for at least one of the test and the previously administered test.

43. A method for controlling quality of a computerized test administered to a human test subject, the method comprising:
administering a computerized test to the test subject in a test environment;
collecting quality control data comprising at least one of audio data, image data and video data relating to at least one of the test subject and the test environment;
analyzing the quality control data to detect, from within the quality control data, a testing anomaly event which may indicate that a reliability of results of the test has been compromised; and
adjusting at least one of the administration and the results of the computerized test in response to a detected testing anomaly event.
